(19) United States
(12) Patent Application Publication
(10) Pub. No.: US 2014/0221565 A1
(43) Pub. Date: Aug. 7, 2014

(54) ALKYD RESIN BASED PAINT WORK COMPOSITION AND A METHOD FOR PREPARING THE SAME

(71) Applicants: KING ABDUL AZIZ CITY FOR SCIENCE AND TECHNOLOGY, Riyadh (SA); CHEMICAL PHYSICS TECHNOLOGIES LTD, Minsk (BY)

(72) Inventors: Mohammed A. Bahattab, Riyadh (SA); Zhdanok Siarhei, Minsk (BY); Krauklis Andrei, Minsk (BY)

(73) Assignees: Chemical Physics Technologies Ltd, Minsk (BY); King Abdul Aziz City for Science and Technology, Riyadh (SA)

(21) Appl. No.: 13/761,091

(22) Filed: Feb. 6, 2013

(51) Int. Cl. C09D 167/00

(52) U.S. Cl. CPC C09D 167/00
USPC 524/599

(57) ABSTRACT

The invention provides an alkyd resin based paint work composition comprising an alkyd resin based film forming material, one or more colorants, one or more fast-drying materials, fumed silica, one or more types of carbon nanotubes and one or more solvents. The invention also provides a method for preparing the alkyd resin based paint work composition.

### FIELD OF THE INVENTION

The invention generally relates to a resin based paint-work composition and a method for preparing the resin based paint work composition. More specifically, the invention relates to an alkyd resin based paint work composition and a method for preparing the alkyd resin based paint work composition.

### BACKGROUND OF THE INVENTION

Resin based paint work materials are widely used in various industries. The resin based paint work materials are mainly used for coating due to their protective and decorative properties. Alkyd resin based paint work materials are particularly used for protective-decorative coating of surfaces such as, but not limited to, metallic surfaces, machinery, devices and wooden surfaces. The alkyd resin based paint work materials are used for forming firm films with high weather resistance and aesthetic properties.

Typically, alkyd resin based paint work materials contain titanium dioxide, talc, calcium carbonate (CaCO₃), white spirit, driers, wetting agent, ant skinning agent and thickener. Such alkyd resin based paint work materials are widely accepted as prototype compositions. An example of such an alkyd resin based paint work material is provided below:

| | In weight percent |
|---|---|
| Composition | (wt %) |
| Alkyd resin | 20-40 |
| titanium dioxide | 17-25 |
| Talc | 12-18 |
| calcium carbonate | 12-18 |
| white spirit | 15-25 |
| Driers | 1.5 |
| Wetting agent | 0.3 |
| Ant skinning agent | 0.2 |
| Thickener | 0.7 |

However, such alkyd resin based paint work materials have low coating hardness, unsatisfactory protective properties, low paint layering and high viscosity index.

Therefore, there is need for an improved alkyd resin based paint work composition and a method for preparing the improved alkyd resin based paint work composition.

### BRIEF DESCRIPTION OF THE DRAWINGS

FIG. 1 illustrates an example alkyd resin-based paint work composition.

FIG. 2 is a flow diagram of an example of a method for preparing an alkyd resin based paint work composition.

### DETAILED DESCRIPTION OF THE INVENTION

Before describing in detail embodiments that are in accordance with the invention, it should be observed that the embodiments reside primarily for an alkyd resin based paint work composition and in method steps related to preparing the alkyd resin based paint work composition.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article or composition that comprises a list of elements does not include only those elements but may include other elements not expressly listed or inherent to such process, method, article or composition. An element proceeded by “comprises . . . a” does not, without more constraints, preclude the existence of additional identical elements in the process, method, article, apparatus or composition that comprises the element.

Generally speaking, pursuant to various embodiments, the invention provides an alkyd resin based paint work composition and a method for preparing the alkyd resin based paint work composition.

In various embodiments of the invention, the alkyd resin based paint work composition comprises an alkyd resin based film forming material, one or more colorants, one or more fast-drying materials, fumed silica, one or more types of carbon nanotubes and one or more solvents. Any suitable alkyd resin based film-forming material can be used for preparing paint work materials and as such would be apparent to those skilled in the art.

The one or more colorants can include, but are not limited to, organic pigments such as azo dyes and polycyclic pigments and inorganic pigments such as iron oxides, zinc chromates, azurite, chromium oxide, cadmium sulphide, lipthopone, zinc oxide and titanium oxide. The one or more fast-drying materials can include, but are not limited to, coordination compounds and metal soaps of carboxylic acids such as cobalt soap, manganese soap, iron metal soap, bismuth soap, zinc oxalate, zinc setrate, cobalt oxalate, cobalt setrate or combination of one or more metal soap. The fumed silica used for preparing the alkyd resin based paint work composition can include, but not limited to, aerosil® and Cab-O-Sil®. The one or more types of carbon nanotubes can include, but are not limited to, single walled carbon nanotubes, double walled carbon nanotubes and multi walled carbon nanotubes. The one or more solvents can include, but not limited to, white spirit, mineral turpentine, acetone, methyl ethyl ketone, toluene and xylene.

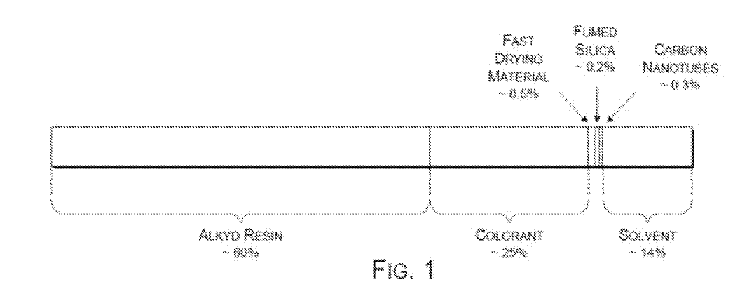

In various embodiments, an example alkyd resin based paint work composition comprises about 30 wt % to about 60 wt % of an alkyd resin based film forming material, about 10 wt % to about 25 wt % of one or more colorants, about 0.1 wt % to about 0.5 wt % of one or more fast-drying materials, about 0.05 wt % to about 0.2 wt % of fumed silica, about 0.025 wt % to about 0.3 wt % of one or more types of carbon nanotubes and one or more solvents for the rest. For example, as shown in FIG. 1, an alkyd resin based paint work composition comprises about 60 wt % of an alkyd resin based film forming material, about 25 wt % of a colorant, about 0.5 wt % of a fast-drying material, about 0.2 wt % of fumed silica, about 0.3 wt % of carbon nanotubes and about 14 wt % of solvent.

In various embodiments of the invention, the method for preparing the alkyd resin based paint work composition comprises mechanically mixing starting materials. The starting materials include an alkyd resin based film forming material, one or more colorants, one or more fast-drying materials, fumed silica, one or more types of carbon nanotubes and one or more solvents.

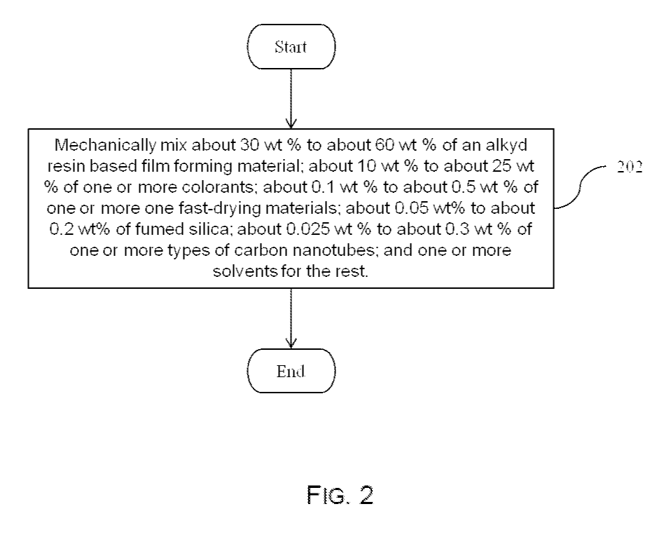

FIG. 2 shows an example of a method for preparing an alkyd resin based paint work composition. The procedure is shown in FIG. 2 as individual blocks. In various embodiments, the example method for preparing the alkyd resin based paint work composition comprises, at block 202 mechanically mixing about 30 wt % to 60 wt % of an alkyd resin based film forming material, about 10 wt % to about 25 wt % of one or more colorants, about 0.1 wt % to about 0.5 wt % of one or more fast-drying materials, about 0.05 wt % to about 0.2 wt % of fumed silica, about 0.025 wt % to about 0.3 wt % of one or more types of carbon nanotubes and one or more solvents for the rest.

In various embodiments, the mechanical mixing is carried out for a period of about 5 minutes to about 20 minutes at a speed of about 1400 rotations per minute (rpm) to 1600 rpm. In an embodiment, the mechanical mixing is carried out for a period of 15 minutes at a speed of about 1450 rpm.

In an exemplary embodiment, PF-133® enamel is used for preparing the alkyd resin based paint work composition. In accordance with the embodiment, the one or more types of CNTs are mechanically mixed with the PF-133® enamel for preparing the alkyd resin based paint work composition. Any other commercially available alkyd resin based enamel can be used for preparing the alkyd resin based paint work composition disclosed herein and as such would be apparent to those skilled in the art.

### Working Example 1

An alkyd resin based paint work composition comprising carbon nanotubes was obtained by mechanical mixing the starting materials together for a period of 15 minutes at a speed of 1450 rpm. The starting materials include 55 ml of alkyd resin, 30 g of titanium oxide, 0.3 g of zinc oxalate, 0.05 g of carbon nanotubes and xylene is used as a solvent to make the volume to 100 ml.

### Working Example 2

An alkyd resin based paint work composition comprising carbon nanotubes was obtained by mechanical mixing 0.05 gm of carbon nanotubes in 50 ml PF-133® enamel for a period of 15 minutes at a speed of 1450 rpm.

Various alkyd resin based paint work compositions comprising different weight percentages (wt %) of carbon nanotubes were prepared using the method described above. Various tests were performed on the alkyd resin based paint work compositions prepared using the method described above. The tests were performed to check the physio-chemical properties of the alkyd resin based paint work compositions. For performing the physio-chemical tests, the alkyd resin based paint work compositions prepared using method described above were ground in a bead mill to obtain particles of about 10 micron (μ) to 20μ in size. The alkyd resin based paint work compositions comprising the particles of about 10 micron (μ) to 20μ in size were allowed to settle for a period of about one week. Thereafter, the physio-chemical tests were performed on the alkyd resin based paint work compositions. The table below provides data regarding the tests performed on the alkyd resin based paint work compositions comprising different weight percentages of carbon nanotubes which were prepared using the method described above. The table provides a comparative data for the physio-chemical properties of the prototype composition and paint work compositions prepared using the method described above.

| | | | | | Time of | | |
|---|---|---|---|---|---|---|---|
| | | Hardness | Adhesion | | sample | | |
| | Carbon | according | according | | cure in | | |
| | nano- | to | back kick | Impact | NaCl | | |
| | tubes | pendulum | cross cut | strength | (3% | Bending | |
| | content | instrument | method | (in | solution) | strength | Layering |
| | (in wt | (in rel. | (in centi- | centi- | -in | (in milli- | in 1 year |
| Composition | %) | units) | meters) | meters) | hours | meters) | period |
| Proto- | 0 | 0.06 | 25 | 100 | 18 | 1 | Yes |
| type | | | | | | | |
| 1 | 0.02 | 0.07 | 30 | 100 | 18 | 1 | No |
| 2 | 0.025 | 0.07 | 38 | 100 | 27 | 1 | No |
| 3 | 0.2 | 0.08 | 100 | 100 | 28 | 1 | No |
| 4 | Opt | 0.11 | 100 | 100 | 28 | 1 | No |
| | 0.162 | | | | | | |
| 5 | 0.3 | 0.11 | 100 | 100 | 28 | 1 | No |
| 6 | 0.35 | 0.11 | 100 | 100 | 26 | 1 | No |
| 7 | 0.162 | 0.07 | 27 | 100 | 20 | 1 | No |
| 8 | 0.162 | 0.11 | 100 | 100 | 27 | 1 | No |
| 9 | 0.162 | 0.11 | 100 | 100 | 28 | 1 | No |
| 10 | 0.162 | 0.11 | 100 | 100 | 28 | 1 | No |

Note:
Opt is the carbon nanotubes value which provides optimal improved physio-chemical properties.

The data in the table above indicates that when carbon nanotubes are dispersed into the alkyd resin based paint work composition, physico-chemical properties of the alkyd resin based paint work composition is improved. Based on various test performed on the alkyd resin based paint work compositions comprising different weight percentages of carbon nanotubes, the optimal quantity of carbon nanotubes which can be dispersed in alkyd resin paint work composition was determined to be about 0.025 wt % to about 0.3 wt %.

When carbon nanotubes are dispersed in alkyd resin based paint work compositions, the film-forming material is reinforced. When the film-forming material is dried, the inner voltage is intensified and shrinkage is reduced. The carbon nanotubes in alkyd resin based paint work compositions facilitate in the formation of harder micro-domains, which in turn increases the hardness of a coating of the alkyd resin based paint work composition. The protective properties of the coating are improved due to formation of a more uniform structure during the process of reinforcement as compared to the prototype composition. The viscosity of paint work compositions is an important aspect for formation of a quality coating. Generally, increase in hard components in paint work composition increases the relative viscosity of the paint work composition. However, using carbon nanotubes in the alkyd resin based paint work compositions reduces the relative viscosity. For example, when 0.1 wt % of carbon nanotubes dispersed in the PF-133® enamel, the relative viscosity is reduced from 255 to 50. Thus, the invention provides an alkyd resin based paint work composition with improved, adhesive, mechanical and barrier properties. These improved properties prolong the life time of the protected surfaces and improve the appearance of the coating.

Those skilled in the art will realize that the above recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A paint work composition comprising:
about 30 weight percentage (wt %) to about 60 wt % of an alkyd resin based film forming material;
about 10 wt % to about 25 wt % of at least one colorant;
about 0.1 wt % to about 0.5 wt % of at least one fast-drying material;
about 0.05 wt % to about 0.2 wt % of fumed silica;
about 0.025 wt % to about 0.3 wt % of at least one type of mechanically mixed carbon nanotubes to provide a reduced working viscosity composition for improved coating formation; and
a balance of at least one solvent;
wherein the composition is mechanically mixed for a period of about 5 minutes to about 20 minutes and at a speed of about 1400 rotations per minute (rpm) to about 3000 rpm to provide the reduced working viscosity and improved coating formation.

2. A method for preparing a paint work composition comprising mechanically mixing:
about 30 wt % to about 60 wt % of an alkyd resin based film forming material;
about 10 wt % to about 25 wt % of at least one colorant;
about 0.1 wt % to about 0.5 wt % of at least one fast-drying material;
about 0.05 wt % to about 0.2 wt % of fumed silica; about 0.025 wt % to about 0.3 wt % of at least one type of carbon nanotubes;
a balance of at least one solvent; and wherein the mechanical mixing is carried out for a period of about 5 minutes to about 20 minutes and at a speed of about 1400 rotations per minute (rpm) to about 3000 rpm to provide a reduced viscosity composition for improved coating formation.

3-4. (canceled)
